(19) United States
(12) Patent Application Publication
(10) Pub. No.: US 2009/0291728 A1
(43) Pub. Date: Nov. 26, 2009

(54) Hot spot

(76) Inventors: Mark Curran Ungaro, Las Vegas, NV (US); Christopher John Nichols, Las Vegas, NV (US)

Correspondence Address: MARK CURRAN UNGARO, 2144 TONA CIRCLE, LAS VEGAS, NV, 89169, US

(21) Appl. No.: 12/154,395

(22) Filed: May 23, 2008

(51) Int. Cl. A63F 13/00

(52) U.S. Cl. 463/13; 463/26

(57) ABSTRACT

The present invention provides a method and apparatus to enhance “Bonus Pay-Outs” and give instant gratification when the player position catches the light. Combining this gaming platform with any traditional live casino game will induce players to interact with other players seated at any live gaming table and with the dealer. This method can be used as an additional betting platform for live casino games including but not limited to Black Jack, Poker, Pai Gow Poker, Pontoon, Mini Baccarat, Baccarat, Craps, Roulette, Three Card Poker, Let It Ride, Caribbean Stud Poker and other games of chance including all Video Reel, Mechanical Reels, Video Keno, Video Roulette, Video Bingo, Video Black Jack, Video Poker, Multi-Hand Video Poker and Nifty Numbers pay-out schedules.

The pay-out will differ from game to game depending on what game is utilized by this method. This method provides a vehicle to designate one to multiple positions on all single hand Video Poker pay-out schedules and is a gaming platform that provides a vehicle to designate one to multiple positions on all multi-hand Video Poker pay-out schedules.

This method is applicable to any non-gaming application for use in promotions, give-a-ways, collection of points for redemption of goods and free commodities.

### BACKGROUND OF THE INVENTION

This present invention provides a method and apparatus for a variation on the traditional casino games wherein participating players of the game make the standard bets within the prescribed wagering positions and then have the opportunity to wager on an additional “purse” bet. The apparatus provides for a stand alone separate wager in any fashion and can be combined with an original wager as an added “bonus payout”. The present method has many applications with a common nexus in that the apparatus can be used virtually, in any gaming format. The present method relates primarily to electronic gaming machines that will encompass games such as Video Reel Slots, Mechanical Reels, Video Bingo, Video Keno, Video Black Jack, Video Poker and Multi-Hand Video Poker.

In the traditional, standard Blackjack rules for example, each card has an assigned value. Each player places a bet and initially receives two-cards, both cards dealt face down. A player may elect to draw additional cards or stand on the cards as dealt. The dealer must draw additional cards until a minimum value of 17 is reached. A Blackjack occurs when a player or the dealer receives an ace and a face card or ten. While a Black Jack by a player typically pays one and a half times the player's initial bet, a Black Jack by the dealer instantly ends the hand, causing each player to lose. Black Jack is a popular card and casino game, but is limited to the extent that each player competes only against the dealer. When a player wins in Black Jack, the player wins a pre-determined amount dependant on the player's initial wager.

Schreiner (U.S. Pat. No. 7,267,343) describes a method for playing a Black Jack game wherein players compete against one another, rather than the dealer. If a player does not have a Black Jack, double Black Jack or 21, the player whose hand value is closest to 21 than that of any other players of the game wins.

Sorge (U.S. Pat. No. 7,222,855) describes a method for playing a modified Black Jack game between a dealer and at least one player. Each player places a first wager, the outcome of which is determined by conventional rules of Black Jack play. Players may optionally place an additional wager or side bet corresponding to a five-card poker hand made up of two cards dealt to the player and three community cards. A predetermined multiple of an amount of the additional wager is paid out or collected based on the rank of the poker hand.

Roberts (U.S. Pat. No. 5,636,843) describes an apparatus and method for adding side or proposition wagers to betting games, particularly the games of Black Jack and Poker. The Black Jack table comprises betting spots each of which includes indicia describing a side proposition bet combination and odds offered for a wager. A special Black Jack side proposition bet entry keyboard is disclosed.

Ungaro et, al (U.S. Pat. No. 7,094,150) teaches an improved roulette game utilizing the existing roulette wheel and/or electronic LED wheel with an existing layout to enhance the game of roulette. Players make wagers on the conventional layout and using the plurality of token or chip acceptors as an extra wager to win either a major progressive jackpot or minor progressive jackpot.

Moody (U.S. Pat. No. 5,823,873) describes a method of playing a card game in which at least two rows of cards are dealt to a player. The player makes a wager for each row of cards. The cards that are held, are duplicated to all the rows. A poker hand ranking of each row is determined.

### SUMMARY OF THE INVENTION

The method of the present apparatus is to increase the excitement and interaction among the players seated at the table while playing any traditional live casino game which is outfitted with this additional side wager gaming platform. This innovative gaming method also increases the excitement on Video Poker Machines and Video Reel Slot Machines and Mechanical Reel Slot Machines, Video Black Jack and Video Roulette when the apparatus is conjoined with either type of machine.

The present method, has features that will enhance existing pay-outs and “Bonus Pay-Outs” and give instant gratification when the player position catches the light. With an instant pay-out and customer participation, the present method creates a winner every hand on a full table game seated by players or customers.

Combining this gaming platform with any traditional live casino game will induce players to interact with other players seated at any gaming table and with the dealer.

The use of this method as the platform for any live casino table game increases the hold for the house. This apparatus can be used on casino games including but not limited to Black Jack, Poker, Pai Gow Poker, Pontoon, Mini Baccarat, Baccarat, Craps, Roulette, Three Card Poker, Let It Ride and Caribbean Stud Poker. The other application of this apparatus is to increase the customer base at any given casino by use of give-away promotions including but not limited to player rewards, points accumulated, room reduction rates, discounted wager practices, or added wagering practices when the randomly generated light stops at a designated player position or the position that is acted upon for the benefits as set forth by the house.

Whatever casino game that is utilized or coupled to with this new apparatus, will enhance the betting action among the players and the house.

The present method is readily evident to those skilled in the art upon reading the following detailed description in combination with the drawings.

### BRIEF DESCRIPTION OF THE DRAWINGS

FIG. 1. Is a top view of the apparatus with a Black Jack game placed into the table-playing surface.

FIG. 2. Is the sensor disk with the chip sensor and light array around the sensor.

FIG. 3. Is a top view of a roulette table apparatus depicting the player positions and playing surface.

FIG. 4. Is a isometric view of the apparatus with a felt being inserted the device table.

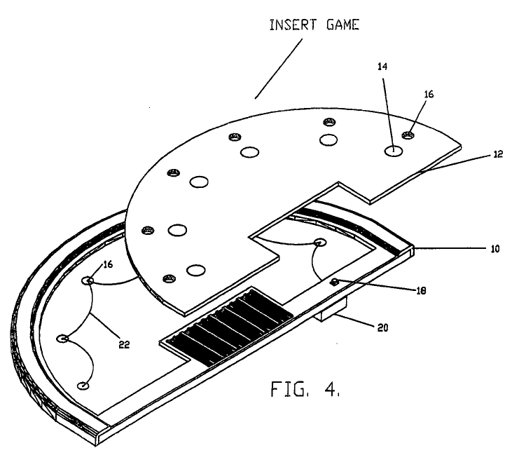

FIG. 5. Is an isometric view of the apparatus utilizing progressive meters for a bonus pay-out system.

FIG. 6. Is the flow chart for using the progressive meters for the apparatus.

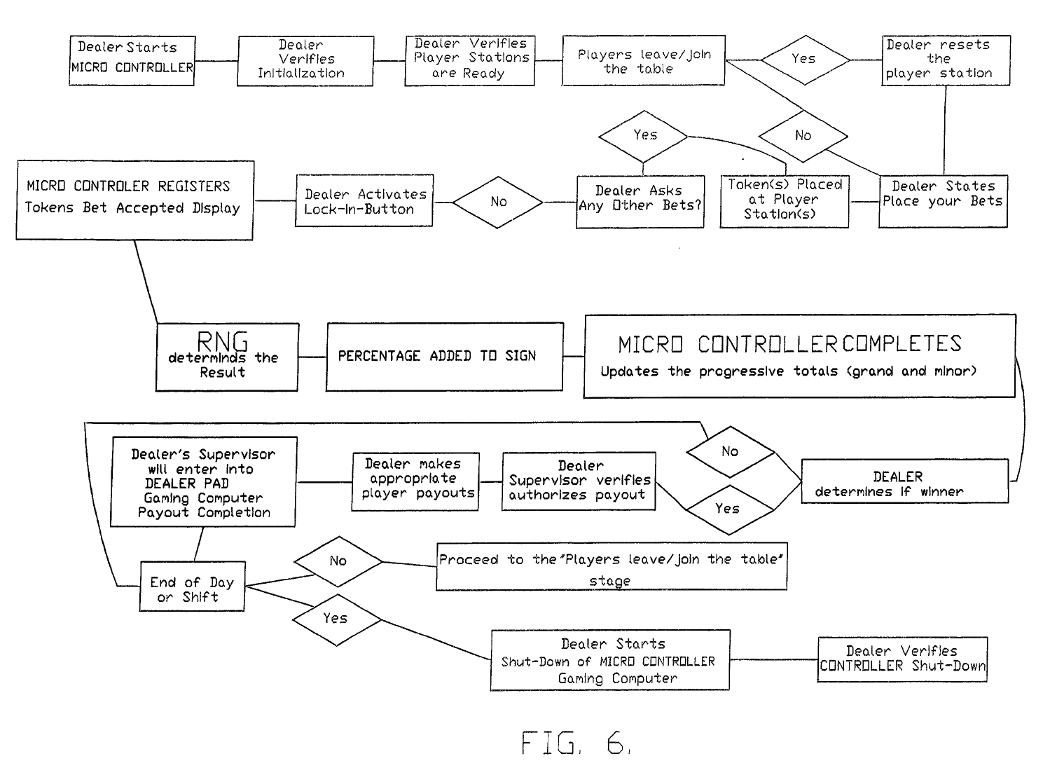

FIG. 7. Is the dealer control panel for the progressive meter payout system.

FIG. 8. Is an isometric view of the apparatus table with an game insert felt being provided.

FIG. 9. Is a video poker machine face with the method added depicting a bonus pay-out.

FIG. 10. Is a analysis of the frequency on hits for the apparatus coupled to the Video Poker Machine.

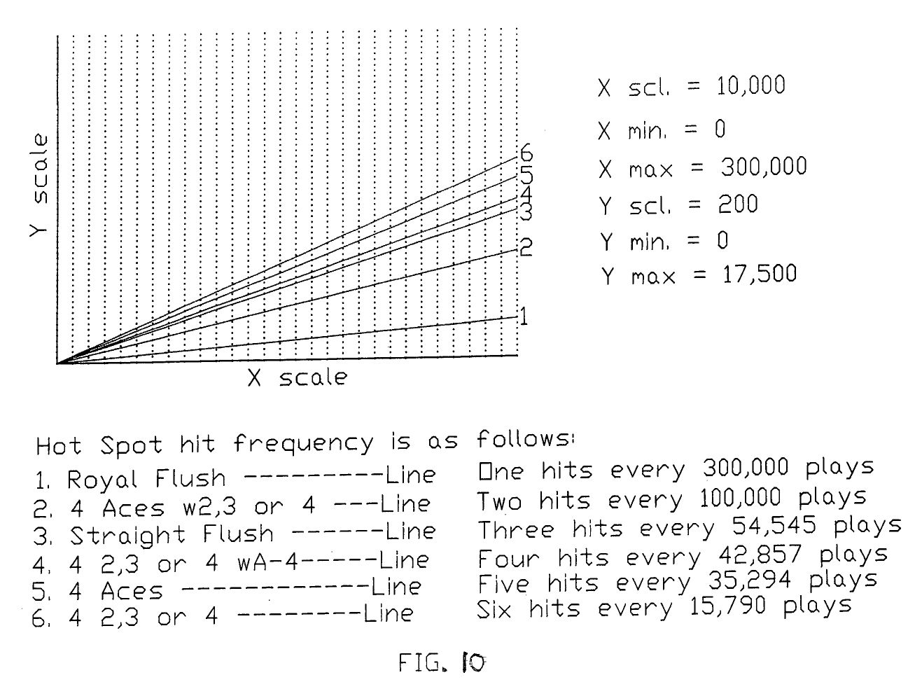

FIG. 11. Is the flow chart for the apparatus when coupled to a standard live game.

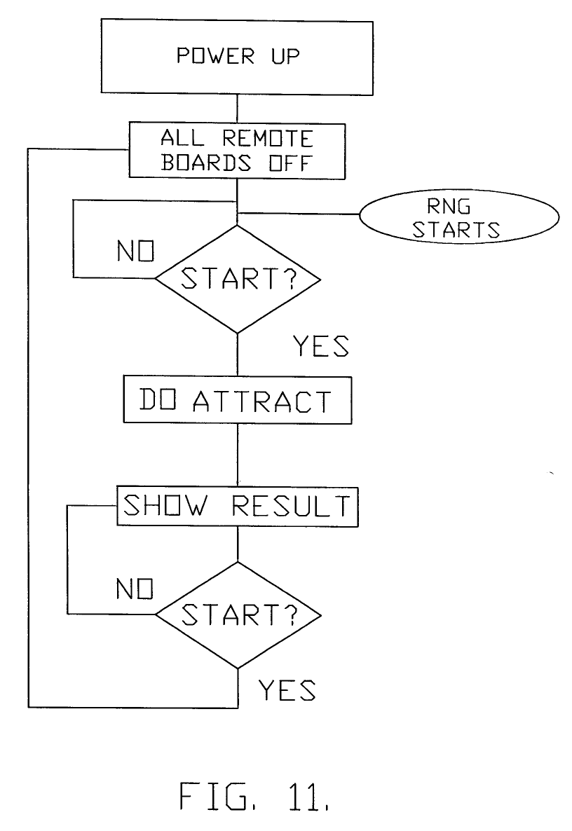

FIG. 12. Is a flow chart used for Video Slot Machines and Video Poker.

FIG. 13. Is a depiction of the method displayed on a Video Black Jack displaying a suited Black Jack.

FIG. 14. Is a depiction of the method displayed on a Video Black Jack displaying a non-suited Black Jack.

FIG. 15. Is a depiction of the method coupled to a Video Roulette Machine.

FIG. 16. Is a top view of the “HOT SPOT” gaming apparatus with just the betting sensors embedded in to the table surface.

FIG. 17. Is a view of a Multi-Hand Video Poker machine with the apparatus coupled to the screen.

FIG. 18. Is a pictorial view of a Video Keno Machine screen displaying the apparatus location.

FIG. 19. Is a pictorial view of a Video Bingo Screen depicting the method used for the game.

FIG. 20. Is a view of the method coupled a group of machines for server based equipment.

### DESCRIPTION OF THE PREFERRED EMBODIMENTS

This method puts a new twist on all old classic table games and new table games alike including Video and Electronic Gaming machines. All recognized standard rules and procedures apply. This is a method is used in a fashion that all live casino table games can be played on the gaming table device. The innovation in this apparatus is that the players play against the house utilizing the Random Number Generator imbedded in the controller 20. The apparatus 10 can accept any game form of gaming felt. Examples of the games that can be used with this method are: Black Jack, Pai Gow, Pai Gow Poker, 1-2 Pai Gow Poker, Six to Five Black Jack, Spanish 21, Three Card Poker, Baccarat, Mini Baccarat, Pontoon, Caribbean Stud Poker, Roulette, Craps to name a few. The Random Number Generator 20 embedded in the apparatus can accept 1 to 99 player positions or as large as you want to make a gaming table for players to interact with.

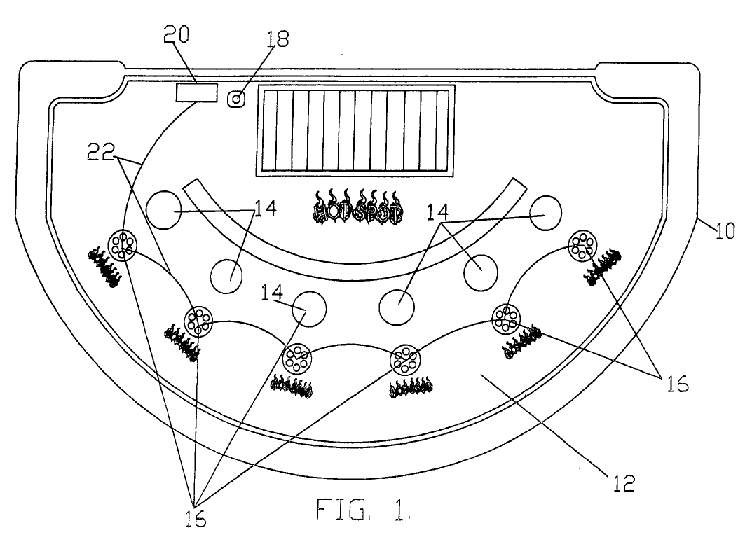

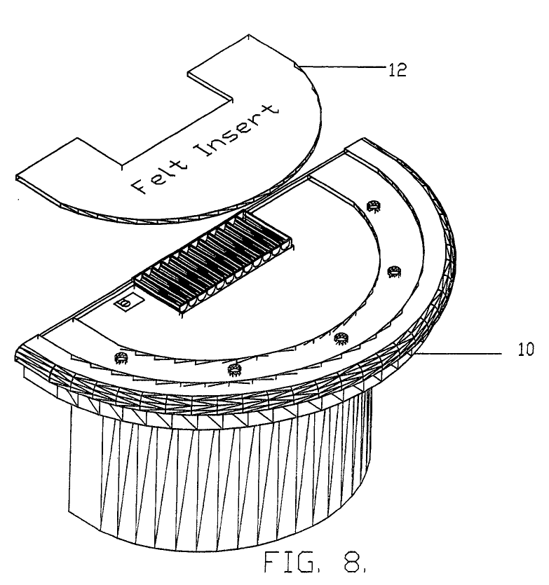

In this first embodiment referring to FIG. 1 and FIG. 8.,. the game surface 12 is a standard Black Jack felt with six player positions 14. The Black Jack playing surface 12 is inserted onto the table apparatus 10. To play the apparatus 16 on the felt, 12 the player must place his first wager amount on the player position 14 and then the player can place a standard prescribed amount (that is determined by the house) on the apparatus sensor position 16. All standard Black Jack rules apply when the apparatus is working on the game that is being dealt to the player. Before the dealer starts to deal the cards to the players, the dealer would ask the players to “place your bets”. The players would then place their wagers on their prescribed player positions 14 and the sensor position 16 if they so desire. The dealer would then press the button 18 activating the micro controller 20 and start dealing the hands of cards to the players. All of the sensor lights 16, connected by the wire harness 22 start blinking and bouncing about the table in a fashion to excite the players and eventually stop at a player position 14. The dealer will collect all losing wagers (the ones not lit) and pay the winning position a 3 to 1 odds pay-off. This is the first round of the emblematic betting action. The second round of wagering is now in action. The players will now look at their cards. The sensor position 16 that is illuminated by the light entitles this player to receive a extra added pay-out should that player have a regular Black Jack which is any two cards comprising of a ten or face card or ace. Because the player has the light in his position, this player will receive an extra pay-out of up to 20 to 1 odds (depending on house preference) on the sensor portion of his wager. By looking at the Data sheet 1., the mathematical analysis states that the player can receive up to a 20 to 1 odds payout for the wager that was bet on position 14. Should the player have a suited Black Jack, which is comprised of a set of two cards that have an ace ten or picture card of the same suit, the player will receive up to a 50 to 1 odds pay-out (depending on house preference) according to the math prescribed for the game. What-ever type game the house inserts into the apparatus table 10, the dealer simply presses the button 18 at his station activating the apparatus 20 setting the method in motion.

Should the light land in front of the player position 14 this player will receive a 3 to 1 pay-out. This equates to a 16.33% hold for the house. Should the player win the hand or spin, and the light is illuminated in front of his position 14 the house can compliment his wager according to house rules governing a pay-out to the player in a form of player rewards, extra money, a reduced rate on hotel room or a free meal.

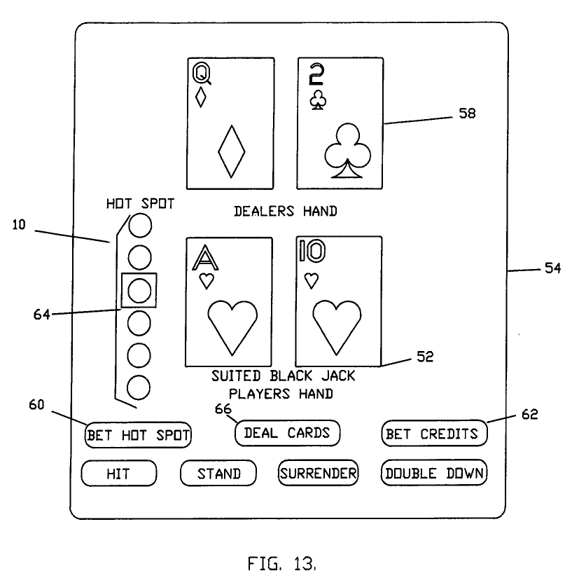

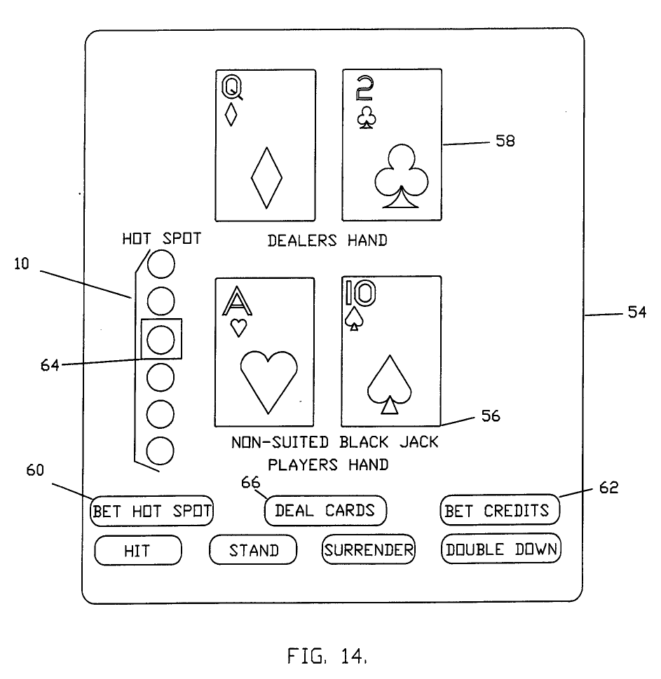

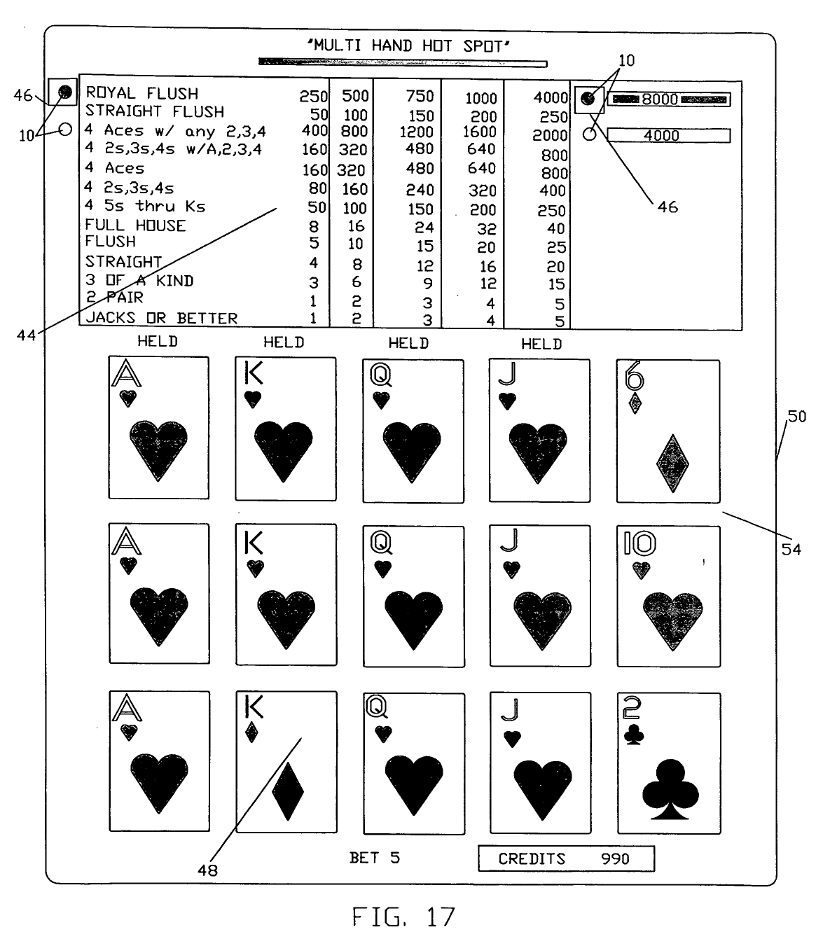

In this second embodiment the apparatus referring to FIG. 13. and FIG. 14., the apparatus is coupled to a Video Black Jack Game. The player would play Video Black Jack as prescribed by the game rules and all formalities. The player would first bet the amount he is willing to wager on the standard game. Then the player can also wager the “HOT SPOT” by pressing an amount to be wagered for the this action 60. The “HOT SPOT” is the box 64 highlighted square. The player then presses the deal cards button 66 and the hands display on the screen 54 This also sets the controller method 20 of the invention in action for the “HOT SPOT” 10 at the same time. There are six “HOT SPOTS”. (More “HOT SPOTS” can be added to increase the odds pay-out if desired. The math can be calculated for any event pay-out.) As you can see, the screen 54 hands dealt by the machine indicate a Queen and a Two for the dealers hand 58 and a Ten and Ace for the players hand 52. The Ten and Ace are suited. Should the “HOT SPOT” stop on the highlighted square 64, the player will win an extra added bonus pay-out because the player was dealt a suited Black Jack, the player “HOT SPOT” will be paid an extra odds pay-out of up to fifty to one instead of the three to one pay-out. If the player does not have a same suited Black Jack as depicted in FIG. 17., then the player will just receive a three to one odds pay-out. The after all hands are dealt and the “HOT SPOT” resets automatically, the Video Black Jack Machine is ready to accept another wager.

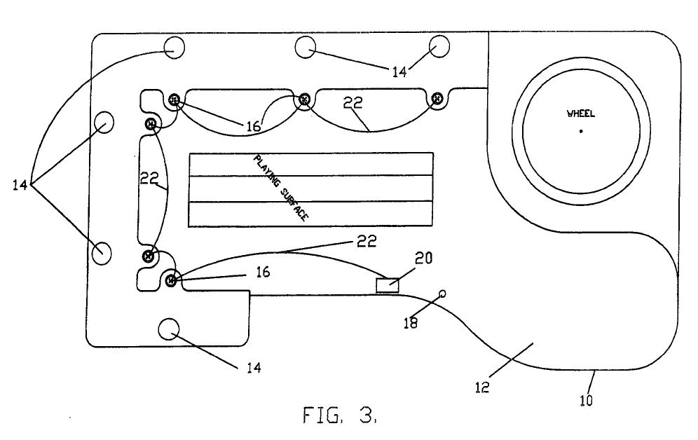

In this third embodiment referring to FIG. 3. there, depicting a roulette game table top 12 with the sensor betting positions 16 embedded into the device table 10. Players are positioned in front of their perspective betting positions 14 at the gaming table 10. A dealer is located behind the back of the table 10 and facing the players. To participate in the game, all players must make their standard wagers from their respective wagering positions 14. Then, players can elect to participate the additional “Bonus” bet by placing a wager on the light sensor position 16 located directly in front of their betting position 14. The player does not have to wager the light position 16 if they choose not to. That player will not get paid the 3 to 1 odds pay-out or a 4 to 1 odds pay-out should the light land on his player position. Lets say for example, that the player does play the “Bonus” position 16, then he is in contention for the 3 to 1 odds pay-out. Should the player win, then the player can use the extra “Bonus” money to play additional wagers on the game surface indica. The house can also use this bonus payout for promotional perks as well. For example: a free drink or room rate reduction or a pass to the show or dinner. The betting procedures for this Roulette play is as follows: The players place their perspective wagers on the sensors 16 and the dealer announces “no more bets” before activating the Random Number Generator button 18 located in the dealer's work area. The micro controller 20 illuminates the sensors lights 16 positioned directly in front of the player positions 14 around all betting positions randomly connected by the wire harness 22, eventually stopping on a single light sensor spot 16. This player is the winner for the 3 to 1 odds “Bonus”. All remaining players' wagers that did not catch the light are collected by the dealer and placed in the designated dealers work area. In the event that the Random Number Generator light stops on a unoccupied player position, all purse wagers are collected by the dealer and treated as a regular wager for the Roulette game. The dealer spins the ball in the wheel and continues on with the standard game of Roulette according to house rules.

The apparatus 10 can be used as a stand-alone game whereas just the lights are on the table and the player just wants to bet the light sensor 16. The dealer simply presses the button 18 activating the controller 20 setting the method in action. When the lights stop randomly moving and land on a player position, the player will win, up to a four to one odds pay-out to the winning position. The losing lights (the ones not lit) will be collected by the dealer. This is a simple but exact apparatus is designed to cause player interaction when wagering with others.

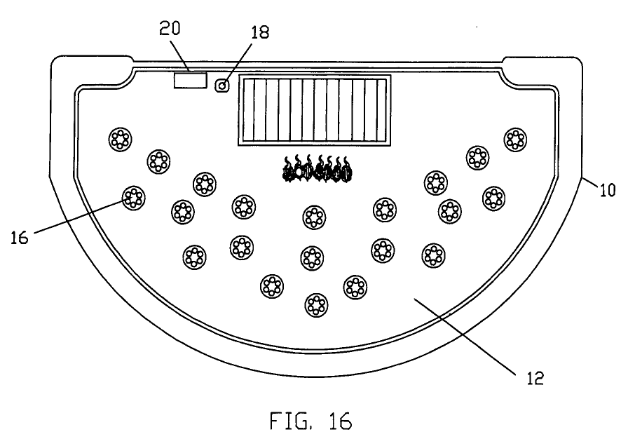

In this forth embodiment the apparatus can just be the “HOT SPOT” betting positions themselves. Referring to FIG. 16., there are many “HOT SPOTS” 16. The players simply place a wager or as many wagers that they like on as many “HOT SPOTS” wanting to win extra bonus pay-outs. The dealer simply makes sure that all wagers are made and then presses the activation button 18 setting the game in action. The controller 20 starts, and all of the lights start bouncing about the table surface and stopping on a single position 16. Some of the betting positions could pay ten to one and other positions could pay three to one or what ever the house decides to pay on a certain betting position. The decision is up to the house. The house just might want to give out promotions in forms of prizes or complimentary beverages or whatever.

The present method includes a variety of video games. Each video game is designed so that the apparatus is coupled to the game and triggered by the action of pressing the same deal button on the existing Video Machine activating the apparatus 10 to display what pay line is chosen that will double the bonus payout.

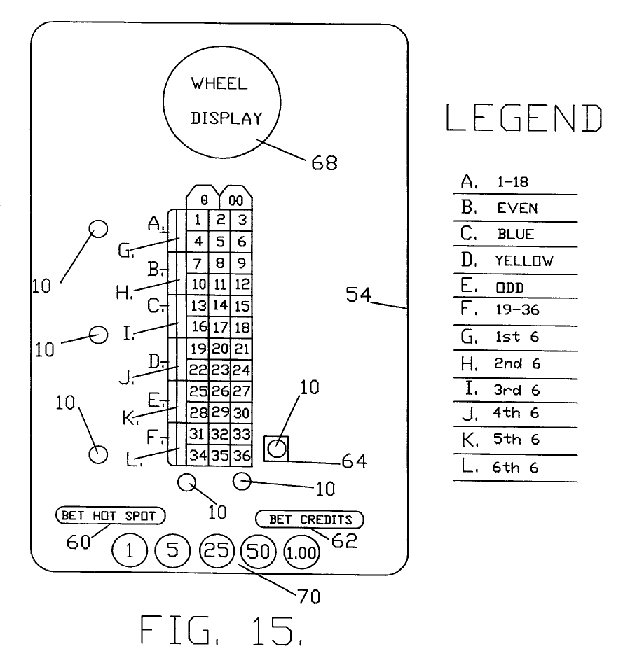

In this fifth embodiment the apparatus can be coupled to a Video Roulette Machine. Referring to FIG. 15., The player would make the standard wagers according to the rules of roulette. The screen 54 is a touch screen so therefore. The player would simply touch the numbers that the player would think to come up. Whatever denomination the player wants to wager is on the screen display 54 chips 70. There is also a “HOT SPOT” betting button 60. If the player wants to wager the “HOT SPOT”, they simply press the credits button 62 and touch whatever “HOT SPOT” 10 they think will come up during the spin of the wheel display 68. The player can touch more than one spot. The odds pay-out can be up to four to one. The odds pay-out can increase by adding more “HOT SPOTS” therefore, increasing better pay-out schedules.

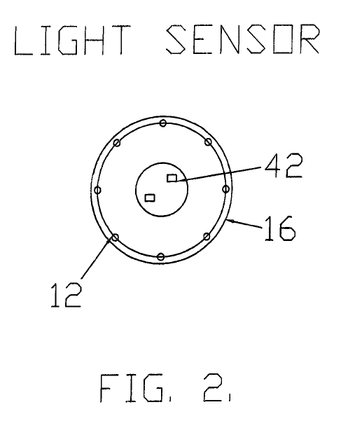

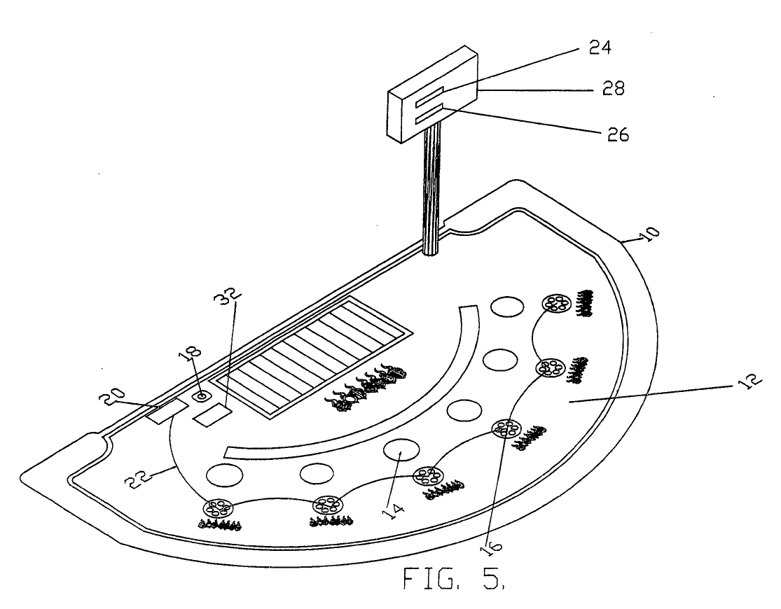

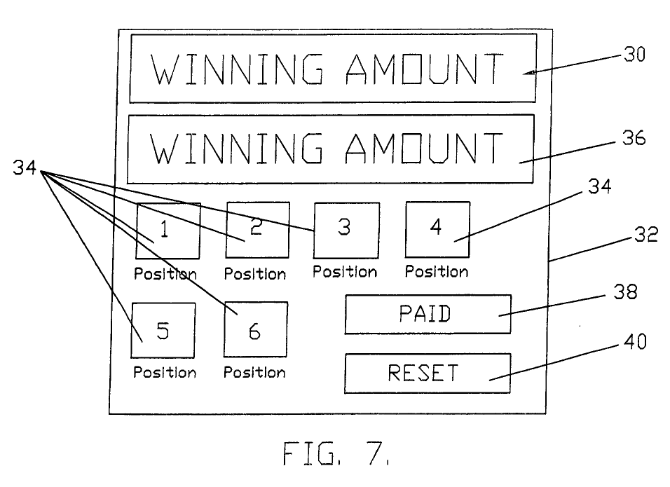

The application of this embodiment is a Continuation-in-part of application Ser. No. 10/642,019, entitled “Pro-Aggressive Roulette” Filed on Aug. 18, 2003 and now U.S. Pat. No. 7,094,150B2. Referring to FIG. 5. and FIG. 7., you can see the device configured utilizing the progressive sign 28 and dealers control pad 32 to convert the apparatus into a progressive payout table with two separate meters (a larger jackpot meter 24 and a small jackpot meter 26). The small jackpot meter will hit more frequently than the larger meter because of the non-suited Black Jack hands appearing more often the suited Black Jack hand combinations. By assigning the smaller meter 26 to the non-suited Black Jack hands and the assigning the larger meter 24 to the suited Black Jack hands and will turn a regular Black Jack game in to a progressive wagering game. The sensor 16 FIG. 2., has a set of light sensors 42 centered in the middle of the device. When the chip is placed upon the sensor, the sensor sends a signal to the controller 20 indicating the a chip has been place upon the progressive portion of the game. The chip will also light up the dealers control panel positions 34 indicating there was a wager placed and adding a percentage to the sign 28. A portion of the percentage can either be added evenly or separately to both large and small meters. The controller is also designed to have a set amount for each jackpot.

The controller 20 is designed to work both utilizing the “HOT SPOT” or the progressive meters in either fashion. In this embodiment, we are using the progressive meters. By using this wagering outline lets the players play for a larger bonus pay-out enhancement. This variation begins as follows: The players simply place their wagers on the progressive sensor 16 and the dealer will ask if there are any more bets. The dealer will lock-in the wagers by pressing the button 18 located on the device 10 before dealing the cards to the player positions 14. The micro controller 20 will sense that there is a chip on the sensor 16 by utilizing the chip light sensors 42 and up-date the meter sign 28 increasing the bonus pay-out and also up-date the dealers control panel 32 and display the amount in the windows 30 and 36 respectfully. Should the player win the bonus progressive with a non-suited Black Jack, the dealer will indicate what position has won by pressing the appropriate number position 34 located on the dealers control panel 32, FIG. 7. After the player has been paid, the supervisor will indicate the transaction by pressing the paid button 38 and reset the jackpot by pressing the button 40 on the dealers control panel.

This gaming device can be utilized in conjunction with any live casino game that has any form of “Bonus” wagering. This apparatus is a gaming platform and is stand alone method designed so that the device will accept any live casino game. The apparatus is designed to be a permanent fixture on the casino floor without changing tables or designs to accept different gaming felts. By using this method, any gaming felt 12 can be inserted into and upon the fixture 10. It does not interfere or infringe on other patented devices. This invention just enhances the existing games that are used in gaming casino's world wide. By using this method, games with a standard “Bonus Pay-Out Schedules” can be readily enhanced to the next level in bonus pay-outs to increase player interaction. Whatever the bonus pay-out should be, on a six player position game for example, you multiply the bonus pay-out by six if the player catches the light and the bonus at the same time. This apparatus just enhances the players chances of winning extra money.

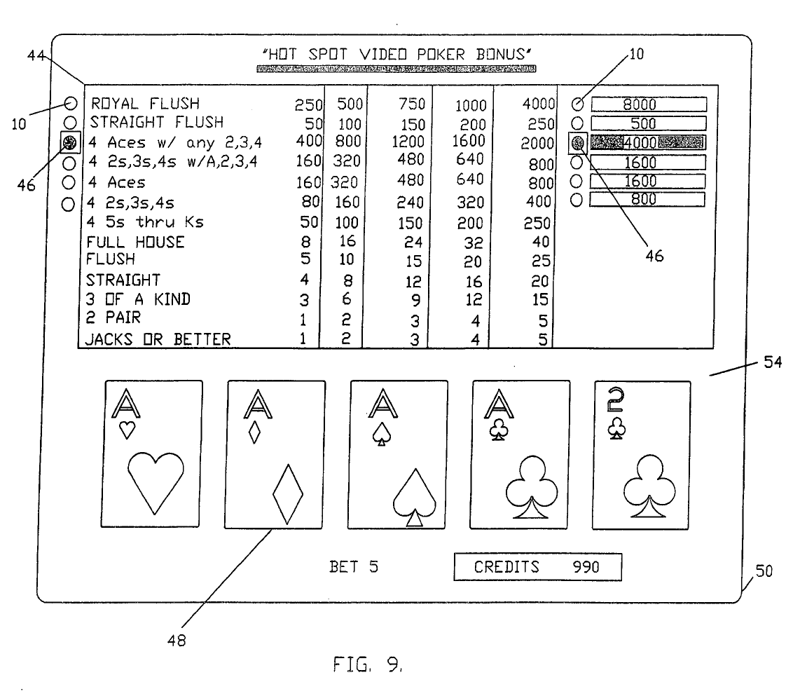

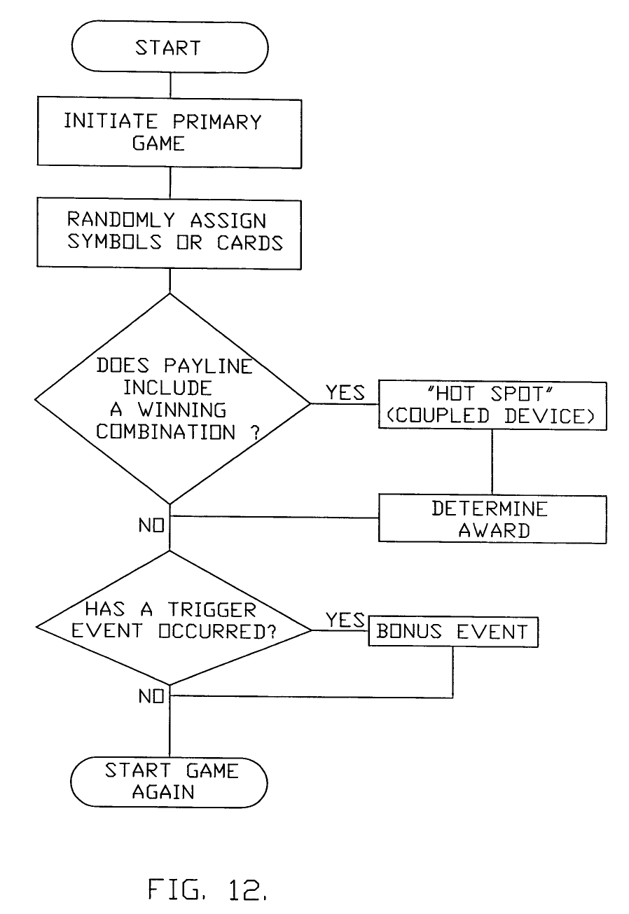

In this sixth embodiment referring to FIG. 9., a Video Poker machine is used in conjunction with this method. The Video Poker Machine is programmed with the apparatus added as an extra bonus payout. The method 10 is displayed along side of the posted pay-out schedule 44 on the machine 50. By removing a few coins or credits from the bottom side of the posted schedule 44, and adding it to the higher pay-outs (Straight Flush for example), you can double the pay-out for the same jackpot hit. See the math data sheet 2 and 2a. for Bonus Poker and graph FIG. 12., for the data. The symbol display 48 (in this case cards) are used to demonstrate a winning combination. The winning combination is 4 aces with a 2 of clubs. Four aces on the pay schedule line displays with maximum coin or credits wagered is 2000. With the device 10 coupled to the pay schedule 44 and happens to be illuminated when the jackpot is hit, the pay-out will be doubled to 4000 as depicted on the screen 46 highlighted in a square box.

This method can be programed to display on a multiple line pay system on a Video Poker Machine FIG. 17., whereas the method 10 can display in other locations depending on house preference for promotional programs adapted by the house. By using this adaptation of the device, the pay-outs and bonus's for each coin wagered from one to multiple coins or credits will enhance player interaction with the machine. This method is adaptable to work on Video Reels and Mechanical Reel Slot Machines as well using the same format except that the Reels display in pay lines. You can have from one to multiple pay lines on a Video Reel depending on the machine. Each pay line can be adapted with the method to pay an extra prescribed bonus pay-out.

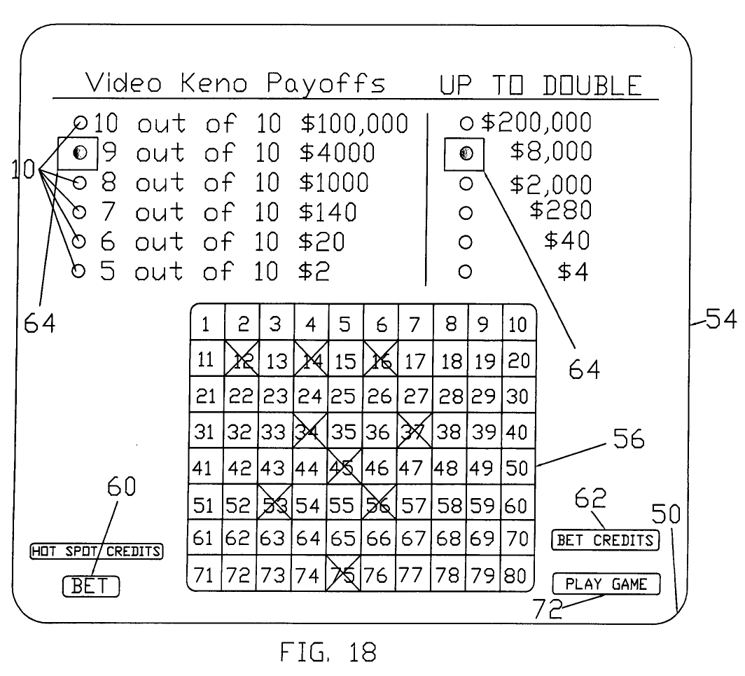

In this seventh embodiment referring to FIG. 18., is a view of a Video Keno screen. The screen is a touch screen that is to industry standards programmed to accept a Video Keno screen with the “HOT SPOT” method coupled to the machine and screen. The “HOT SPOT” circles 10 represent the enhanced “Bonus” pay-out schedule. First, the player decides how much he wants to wager on this particular round of play. The player just simply touches the numbers that the player expects to win on that are represented by the X. Then, the player decides how many credits are played by pressing the credits button 62. If the player decides to play the “HOT SPOT”, the player presses the “HOT SPOT” credits button 60 to have the “HOT SPOT”in action. The player now presses the play game button 72 to start the game in action. Should the player win the desired numbers that were picked and the “HOT SPOT” happens to be on the winning number combination (in this case 9 out of 9) the box highlighted 64 will increase the pay-out up to double.

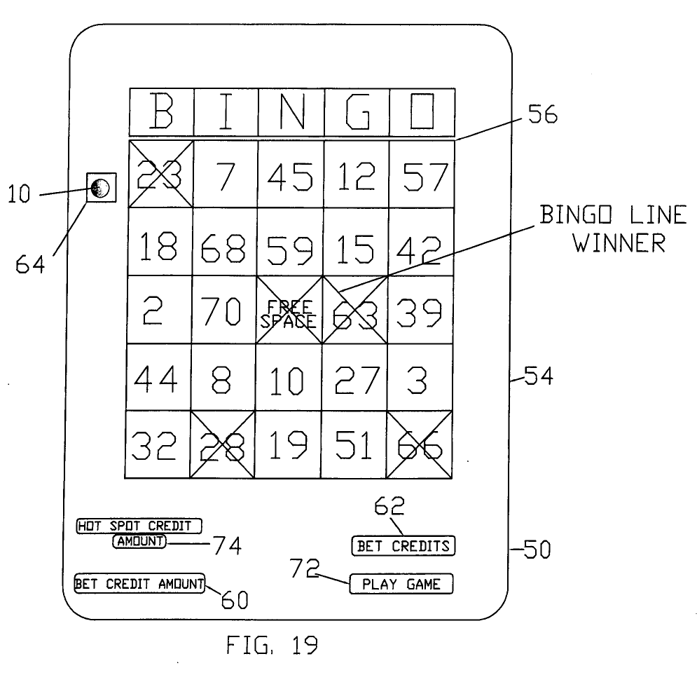

In this eighth embodiment referring to FIG. 19., is a view of a Video Bingo screen utilizing the method. The player simply bets the minimum credit wagers 62 needed to play the game and then the “HOT SPOT” credit amount 74 if the player desires he wants extra bonus action. The player touches the bet credit amount button 60 and it adds to the amount 74. Should the player win the “BINGO GAME” and the “HOT SPOT” method 10 is lit and highlighted 64, the player will receive an extra added bonus that is prescribed by the house.

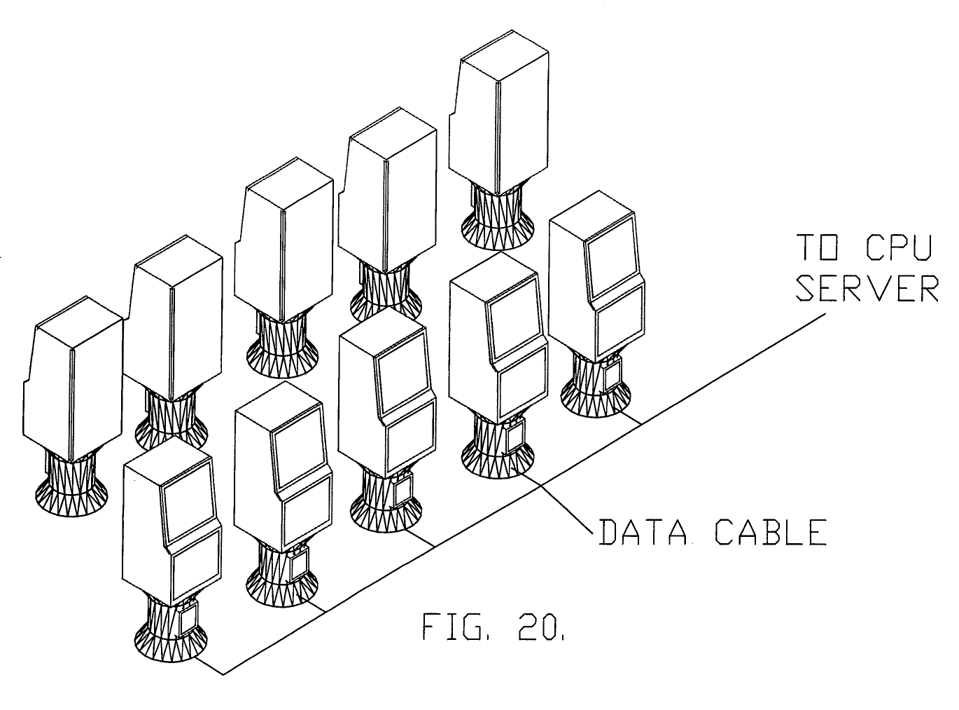

In this final embodiment this method of displaying a winning out come for a “HOT SPOT” on any Gaming Machine including Video Poker, Video Reels, Video Black Jack, Video Keno and Video Bingo can be achieved by a server based system located in a separate location. FIG. 20. The casino operator has at his disposal, a central processing unit (CPU) linked to numerous gaming machines designed so that the machines can have the “HOT SPOTS” moved to different machine group locations on the server based machines for purposes of moving players to different locations on the property to expose the players to different forms of gaming experiences.

What is claimed is:

1. A gaming method comprising ways of:
a. allowing a player to make at minimum one wager;
b. using sensors to randomly select a bonus event and option;
c. determining whether an event has occurred providing one additional option of initiating an additional bonus event based solely on the determination of said trigger;
d. awarding a payout if said winning sensor is triggered during course of play;
e. determining whether a winning position is present at least in one position when triggered.

2. The gaming method of claim 1. further comprising allowing a player to be randomly selected on the formation of sites and allowing said bonus event by:
displaying a light source image of a bonus payout event; and determining whether one is present of said bonus event.

3. The gaming method of claim 1. wherein said sequential lights are randomly arranged and said lights appear on said game apparatus substantially in conventional sequence.

4. The gaming method according to claim 1. wherein said sequential indicia are randomly arranged and said playing symbols appear on said game boards substantially in conventional sequence.

5. A apparatus comprising:
a plurality of light sensors, each of said game apparatus including at least 1 or more locations having sequential indicia, each of said locations including a light source of a different bonus amount being randomly arranged on each light source so that a representation of each light source appears in one of said locations, each of said apparatus having a different arrangement of playing light symbols within its locations; and means for randomly generating a series of light representation corresponding to said bonus payout whereby upon operation of the said generating means, each apparatus has associated therewith a light source consisting of the playing apparatus, symbolized in the locations corresponding to the series of indicia thus generated.

6. A method according to claim 5. further comprising means for using a series of light emitting diodes marking individual locations when indicia within said locations have been generated whereby all playing card symbols in said poker hands are collectively identifiable.

7. A method according to claim 5. wherein each gaming machine comprises at least one additional location including a visible representation of a hot spot.

8. A method according to claim 5. wherein said visible representation of a hot spot appears in the same location on each of said apparatus.

9. A apparatus according to claim 5. wherein said hot spot symbol appears in a least two different locations.

10. A apparatus comprising:
a array of light emitting diodes, each of said array of diodes of different contest with rules, said diodes arranged by means of appearing one time on each game, thus defining a location associated with each hand, and sequential indicia randomly arranged on each player screen so that one said indicia appears in each said locations, each of said screens having a different arrangement of indicia with its locations; and means for randomly generating a corresponding to said sequential indicia, whereby upon operation of said generating means, each screen has associated therewith a poker hand consisting of playing cards symbolized in the locations corresponding to the series of indicia thus generated.

11. A method of playing and wagering a game having thereon a plurality of light sensors corresponding to the player positions providing additional wagering positions thereby receiving a progressive jackpot and comprising the steps of:
a. each player placing a wager on the surface of the ambient light sensor to participate in the progressive jackpot portion of the game by;
using a start button located by the main control panel activating a timed counting cycle to visibly display a random light source associated with the player positions on a live layout by;
b. a method for detecting a winning position and calculating a pay out of an accumulated amount of a jackpot condition and recycling to a set amount by;
c. means of a pre-set jackpot amount or accumulated jackpot amount.

12. A method of playing and wagering a game coupled to at least one pay line on a video gaming machine determining a winning symbol line providing a additional bonus payout.

13. A method according to claim 12. of detecting winning pay line on a video gaming machine and calculating a pay out of an accumulated amount of a jackpot condition and recycling to a set amount by means of a pre-set jackpot amount or accumulated jackpot amount.

14. A computer controlled display system including at least one server based central processing unit (CPU), said CPU coupled to at least one display for displaying a game and image on said display comprising:
storage means coupled to said CPU for storing at least one game play text file, and at least one symbol image document comprised of a image file, said equivalent text file including linking information that links at least one portion of said equivalent text file to at least one portion of said image file, said equivalent text file also including equivalency information detailing an equivalency relationship between said symbol image file and a corresponding text file, said equivalency information comprising;
at least one symbol set of information specifying at least one mapping of a group of symbols and said files to a special storage file by locating information in said image files of items referred to in said array of image files.
